(19) United States
(12) Patent Application Publication
(10) Pub. No.: US 2018/0062418 A1
(43) Pub. Date: Mar. 1, 2018

(54) ELECTRONIC DEVICE SYSTEM

(71) Applicant: Electronics and Telecommunications Research Institute, Daejeon (KR)

(72) Inventors: Sang Hoon CHEON, Daejeon (KR); Hojun RYU, Seoul (KR)

(73) Assignee: Electronics and Telecommunications Research Institute, Daejeon (KR)

(21) Appl. No.: 15/617,659

(22) Filed: Jun. 8, 2017

(30) Foreign Application Priority Data
Aug. 23, 2016 (KR) 10-2016-0107249
Dec. 2, 2016 (KR) 10-2016-0163877

(51) Int. Cl. H02J 7/02; H01F 38/14; H01F 27/28; H02J 50/12; H04R 1/10

(52) U.S. Cl. CPC H02J 7/025; H01F 38/14; H01F 27/288; H04R 2420/07; H04R 1/1025; H04R 1/1016; H02J 50/12

(57) ABSTRACT

Provided is an electronic device system. The electronic device system includes an electronic device having an open loop shape and a coil within the electronic device. The coil includes a first coil part through which current flows in a first direction, a second coil part through which current flows in a second direction opposite to the first direction, and a shield unit provided to at least one of the first coil part or the second coil part.

### CROSS-REFERENCE TO RELATED APPLICATIONS

This U.S. non-provisional patent application claims priority under 35 U.S.C. §119 of Korean Patent Application Nos. 10-2016-0107249, filed on Aug. 23, 2016, and 10-2016-0163877, filed on Dec. 2, 2016, the entire contents of which are hereby incorporated by reference.

### BACKGROUND

The present disclosure herein relates to an electronic device system, and more particularly, to an electronic device system having an open loop shape and realizing resonant wireless power transmission.

A resonant wireless power transmission technology is a technology that transmits energy via wireless through mutual resonance phenomenon by using magnetic resonators having the same resonant frequencies as each other. For the resonant wireless power transmission technology, a resonant coil and a power feeding coil have to be present in each of a transmitting part and a receiving part. However, in order to be loaded in an electronic device, built-in coils may have limited structures according to shapes of the electronic device. Particularly, coils built in an electronic device system (for example, a headset) having an open loop shape may have a structural limitation.

### SUMMARY

The present disclosure provides an electronic device system with an open loop shape capable of having high inductance.

The object of the present disclosure is not limited to the aforesaid, but other objects not described herein will be clearly understood by those skilled in the art from descriptions below.

An embodiment of the inventive concept provides an electronic device system including: an electronic device having an open loop shape; a coil within the electronic device; and a shield unit configured to shield at least a portion of the coil, wherein the coil includes: a first coil part through which current flows in a first direction; and a second coil part through which current flows in a second direction opposite to the first direction, wherein the shield unit is provided to at least one of the first coil part or the second coil part.

In an embodiment, the coil may be a single coil having the open loop shape, and the first coil part may be a portion of the coil, and the second coil part may be another portion of the coil.

In an embodiment, the coil may have the open loop shape, and the second coil may be provided inside further than the first coil part, and the shield unit may be provided to the second coil part.

In an embodiment, the shield unit may be provided to surround the second coil part.

In an embodiment, the coil may be a receiving-side resonant coil.

In an embodiment, the coil may be a receiving-side power feeding coil.

In an embodiment, at least one of the first coil part or the second coil part may be provided in plurality.

In an embodiment, the coil includes: a receiving-side resonant coil; and a receiving-side power feeding coil, wherein each of the receiving-side resonant coil and the receiving-side power feeding coil includes the first and second coil parts, wherein the shield unit includes: a first shield unit provided to the receiving-side power feeding coil; and a second shield unit provided to the receiving-side resonant coil.

In an embodiment, the electronic device system may further include a wireless charger configured to charge the electronic device.

In an embodiment, the wireless charger may include: a transmitting-side power feeding coil; and a transmitting-side resonant coil.

In an embodiment, the coil may be a receiving-side power feeding coil, wherein the wireless charger includes: a transmitting-side power feeding coil; a transmitting-side resonant coil; and a receiving-side resonant coil.

In an embodiment, the electronic device may be charged when disposed at a charging position adjacent to the wireless charger, and a distance between the electronic device and the wireless charger may be about 10 cm or less at the charging position.

In an embodiment, the electronic device may be a headset.

In an embodiment of the inventive concept, a wireless charger for charging an electronic device includes: a transmitting-side power feeding coil; a transmitting-side resonant coil; and a receiving-side resonant coil.

In an embodiment, the wireless charger may charge the electronic device when the electronic device is disposed at a charging position adjacent to the wireless charger, and a distance between the electronic device and the wireless charger may be about 10 cm or less at the charging position.

Particularities of other embodiments are included in the detailed description and drawings.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a view of an electronic device system according to an embodiment of the inventive concept;

FIG. 2 is a view illustrating internal structures of the electronic device system of FIG. 1;

FIG. 3 is schematic views of a receiving-side power feeding coil and a receiving-side resonant coil of FIG. 2;

FIG. 4 illustrates a wireless power supply system of the electronic device system of FIG. 1;

FIG. 5A is a view of a receiving-side power feeding coil according to an embodiment of the inventive concept;

FIG. 5B is a cross-sectional view of magnetic fields, taken along line A-A′ of FIG. 5A;

FIG. 6A is a view of a receiving-side power feeding coil according to a comparative example;

FIG. 6B is a cross-sectional view of magnetic fields, taken along line B-B′ of FIG. 6A;

FIG. 7 is a view of a receiving-side power feeding coil according to an embodiment of the inventive concept;

FIG. 8 is a view of an electronic device system according to an embodiment of the inventive concept; and

FIG. 9 illustrates a wireless power supply system of the electronic device system of FIG. 8.

### DETAILED DESCRIPTION

Advantages and features of the present disclosure, and implementation methods thereof will be clarified through following embodiments described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Further, the present disclosure is only defined by scopes of claims. Like reference symbols refer to like elements throughout.

In this specification, the terms are used only for explaining specific exemplary embodiments while not limiting the present disclosure. In this specification, the terms of a singular form may include plural forms unless specifically mentioned. The meaning of ‘comprises’ and/or ‘comprising’, when used in this specification, specifies a component, a step, an operation and/or an element described, but does not exclude the presence or addition of one or more other components, steps, operations and/or elements.

Additionally, the embodiments described in this specification will be explained with reference to the cross-sectional views and/or plan views as ideal exemplary views of the present disclosure. In the figures, the thicknesses of films and regions are exaggerated for effective description of the technical contents. Accordingly, shapes of the exemplary views may be modified according to manufacturing techniques and/or allowable errors. Therefore, the embodiments of the present disclosure are not limited to the specific shape illustrated in the exemplary views, but may include other shapes that may be created according to manufacturing processes. Therefore, areas exemplified in the drawings have general properties, and shapes of areas exemplified in the drawings are used to illustrate a specific shape of a device region. Thus, this should not be construed as limited to the scope of the present disclosure.

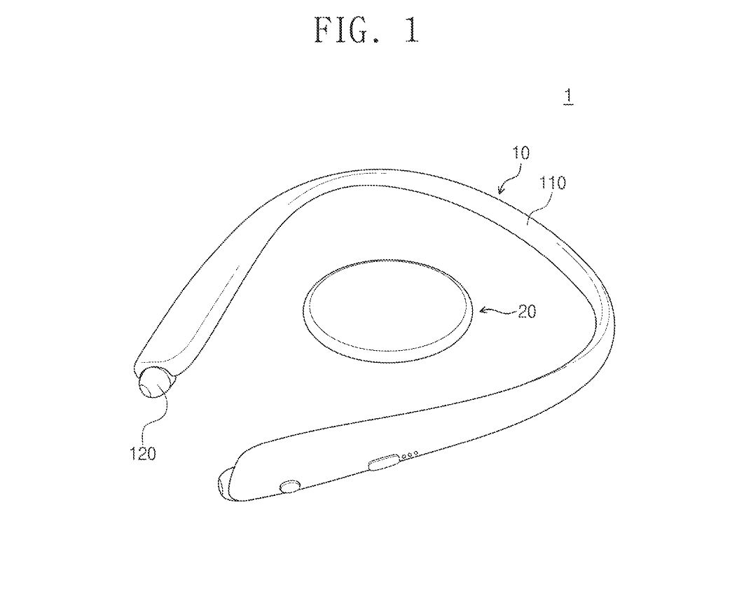

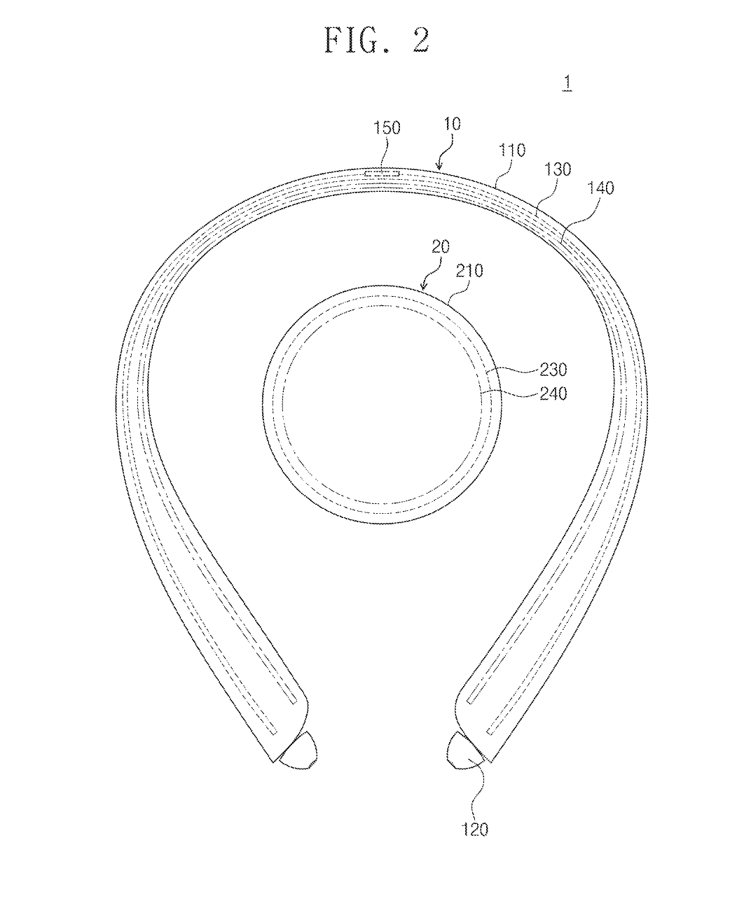

FIG. 1 is a view of an electronic device system 1 according to an embodiment of the inventive concept. FIG. 2 is a view illustrating internal structures of the electronic device system 1 of FIG. 1. Referring to FIGS. 1 to 2, the electronic device system 1 according to the embodiment of the inventive concept will be described. The electronic device system 1 may include an electronic device 10 and a wireless charger 20. The electronic device 10 according to the embodiment of the inventive concept may have an open loop shape. In the specification, the open loop shape means a non-closed ring shape (that is, not connected to each other). The open loop shape may be a circular loop or a polygonal loop. For example, the electronic device 10 may be a headset but is not limited thereto.

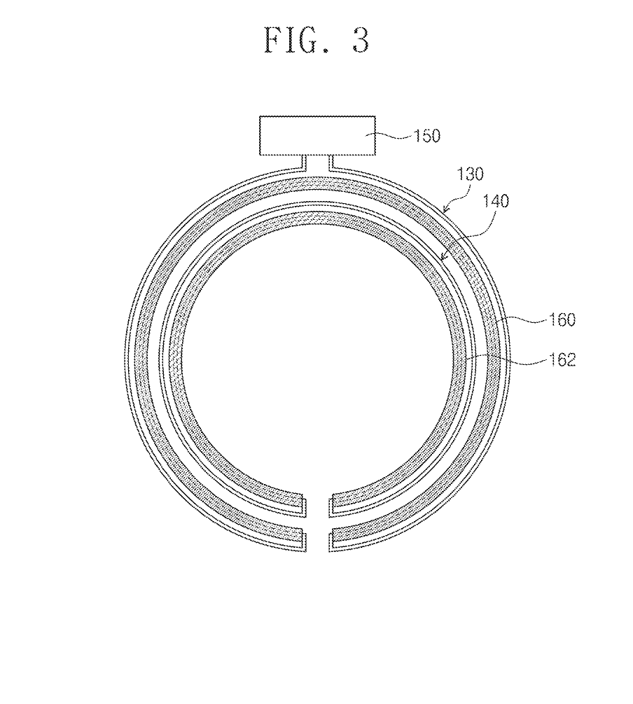

The electronic device 10 may include a first body 110, an earphone 120, a receiving-side power feeding coil 130, a receiving-side resonant coil 140, a receiving circuit unit 150, and shield units 160 and 162 of FIG. 3. The first body 110 may have an open loop shape. The earphone 120 may be provided in ends of the first body 110.

The receiving-side power feeding coil 130, the receiving-side resonant coil 140, and the receiving circuit unit 150 are provided within the first body 110. Referring to FIG. 2, the receiving-side power feeding coil 130 is illustrated by a dotted line, and the receiving-side resonant coil 140 is illustrated by an alternate long and short dash line. Although each of the receiving-side power feeding coil 130 and the receiving-side resonant coil 140 is illustrated by a single line for simplicity of the drawing in FIG. 2, each of the receiving-side power feeding coil 130 and the receiving-side resonant coil 140 has a volume as illustrated in FIG. 3.

FIG. 3 is schematic views of the receiving-side power feeding coil 130 and the receiving-side resonant coil 140 of FIG. 2. Referring to FIGS. 2 and 3, each of the receiving-side power feeding coil 130 and the receiving-side resonant coil 140 may have a shape corresponding to the first body 110. When viewed in a plane, each of the receiving-side power feeding coil 130 and the receiving-side resonant coil 140 may have an open loop shape. The receiving-side power feeding coil 130 may be disposed outside further than the receiving-side resonant coil 140, and the receiving-side resonant coil 140 may be disposed inside further than the receiving-side power feeding coil 130. In other words, the receiving-side power feeding coil 130 may be adjacent to a center of the first body 110 than the receiving-side resonant coil 140. However, an arrangement relation thereof is a merely illustrative and is not limited thereto. For example, the receiving-side power feeding coil 130 and the receiving-side resonant coil 140 may have the same sizes and shapes as each other and be provided to be stacked on each other. The receiving-side power feeding coil 130 may be electrically connected to the receiving circuit unit 150. The receiving-side power feeding coil 130 may have both ends connected to the receiving circuit unit 150.

The shield units 160 and 162 may include a first shield unit 160 and a second shield unit 162. The first shield unit 160 may be provided in the receiving-side power feeding coil 130, and the second shield unit 162 may be provided in the receiving-side resonant coil 140. A detail structure of the coil and the shield units 160 and 162 will be described later.

Again, referring to FIGS. 1 and 2, the wireless charger 20 may include a second body 210, a transmitting-side power feeding coil 230, and a transmitting-side resonant coil 240. Referring to FIG. 2, the transmitting-side power feeding coil 230 is illustrated by a dotted line, and the transmitting-side resonant coil 240 is illustrated by an alternate long and short dash line. The second body 210 may have various shapes, for example, may be provided with a circular shape. The transmitting-side power feeding coil 230 and the transmitting-side resonant coil 240 may be disposed within the second body 210. Since the second body 210 is not limited to the shape, each of the transmitting-side power feeding coil 230 and the transmitting-side resonant coil 240 may be provided with a closed loop. For example, although each of the transmitting-side power feeding coil 230 and the transmitting-side resonant coil 240 may be provided with a spiral coil wound in a plurality of times, a detail illustration thereof is omitted for simplicity of the drawing in FIG. 2. Although not shown, the wireless charger 20 may include a power source.

The electronic device 10 may be charged from the wireless charger 20 by disposing the electronic device 10 to a first charging position adjacent to the wireless charger 20. For example, a distance between the electronic device 10 and the wireless charger 20 may be about 30 cm or less at the first charging position.

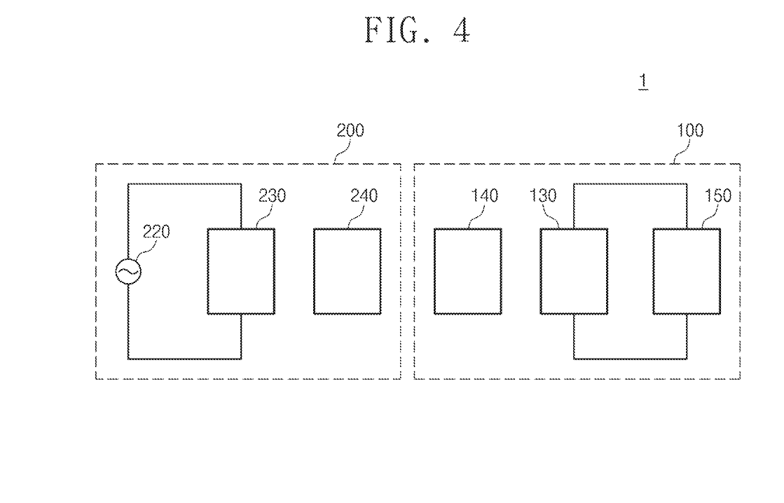

FIG. 4 illustrates a wireless power supply system of the electronic device system 1 of FIG. 1. The wireless charger 20 may be corresponded to a wireless power transmitting device 200, and the electronic device 10 may be corresponded to a wireless power receiving device 100. The receiving-side resonant coil 140 of the wireless power receiving device 100 has the same resonant frequency as the transmitting-side resonant coil 240 of the wireless power transmitting device 200. The wireless power transmitting device 200 may transfer power generated in a power source 220 to the wireless power receiving device 100. For example, the power may be transferred by magnetic resonance phenomenon. The power source 220 may be an AC power source. The power source 220 is described to be provided within the wireless power transmitting device 200 as an example, but on the contrary, the power source 220 may be provided outside the wireless power transmitting device 200.

The wireless power transmitting device 200 may include the transmitting-side power feeding coil 230 and the transmitting-side resonant coil 240. The transmitting-side power feeding coil 230 is connected to the power source 220, and then current may flow. When the current flows through the transmitting-side power feeding coil 230, induced current may be induced in the transmitting-side resonant coil 240 spaced therefrom by electromagnetic induction. The power transferred to the transmitting-side resonant coil 240 may be transferred to the wireless power receiving device 100 constituting a resonant circuit with the wireless power transmitting device 200 by the magnetic resonant phenomenon. Although not shown, the wireless power transmitting device 200 may further include a convertor and the like to convert one of alternating current, direct current, and RF to another one.

The wireless power receiving device 100 may include the receiving-side power feeding coil 130, the receiving-side resonant coil 140, and the receiving circuit unit 150. The receiving-side resonant coil 140 receives the power transmitted by the transmitting-side resonant coil 240, and current may flow through the receiving-side resonant coil 140. The power transferred to the receiving-side resonant coil 140 may induce the induced current in the receiving-side power feeding coil 130 by the electromagnetic induction. The power transferred to the receiving-side power feeding coil 130 may be transferred to the receiving circuit unit 150. The receiving circuit unit 150 may include a rectifier circuit and/or a load and the like.

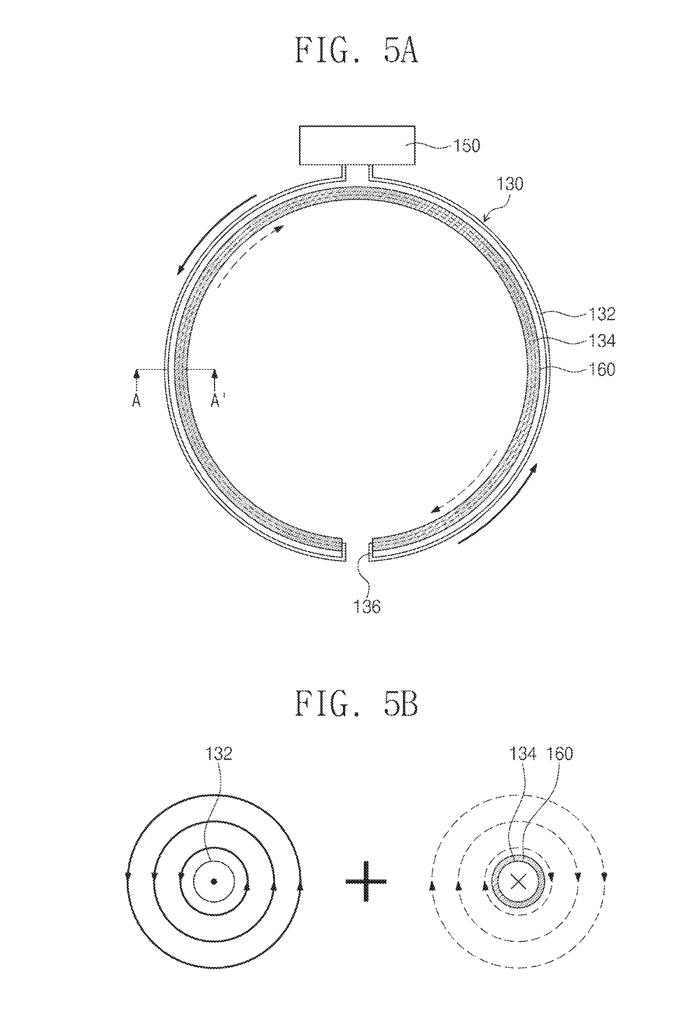

FIG. 5A is a view of the receiving-side power feeding coil 130 according to the embodiment of the inventive concept, and FIG. 5B is a cross-sectional view of magnetic fields, taken along line A-A′ of FIG. 5A. Referring to FIGS. 5A and 5B, the receiving-side power feeding coil 130 may include a first coil part 132, a second coil part 134, and a connection part 136. The first coil part 132 is a portion of the receiving-side power feeding coil 130 through which current flows in a first direction, and the second coil part 134 is another portion of the receiving-side power feeding coil 130 through which current flows in a second direction opposite to the first direction. For example, the first coil part 132 may be an outside loop portion of the receiving-side power feeding coil 130, and the second coil part 134 may be an inside loop portion of the receiving-side power feeding coil 130. In other words, the second coil part 134 may be adjacent to a center of the receiving-side power feeding coil 130 than the first coil part 132. The connection part 136 may connect the first coil part 132 to the second coil part 134.

The first shield unit 160 may be provided to one of the first coil part 132 and the second coil part 134. For example, the first shield unit 160 may be provided to surround the second coil part 134 as illustrated in FIG. 5A. The first shield unit 160 may have a shielding material capable of shield the magnetic field. The first shield unit 160 may surround the second coil part 134, but on the other hand, be provided as a shielding sheet and the like. Referring to FIGS. 5A and 5B, since current having different directions flow through the first coil part 132 and the second coil part 134, magnetic fields having different direction may be generated. Since the magnetic filed generated in the second coil part 134 is able to be shielded by providing the shield unit 160 to the second coil part 134, a cancellation of the receiving-side power feeding coil 130 may decrease to increase inductance.

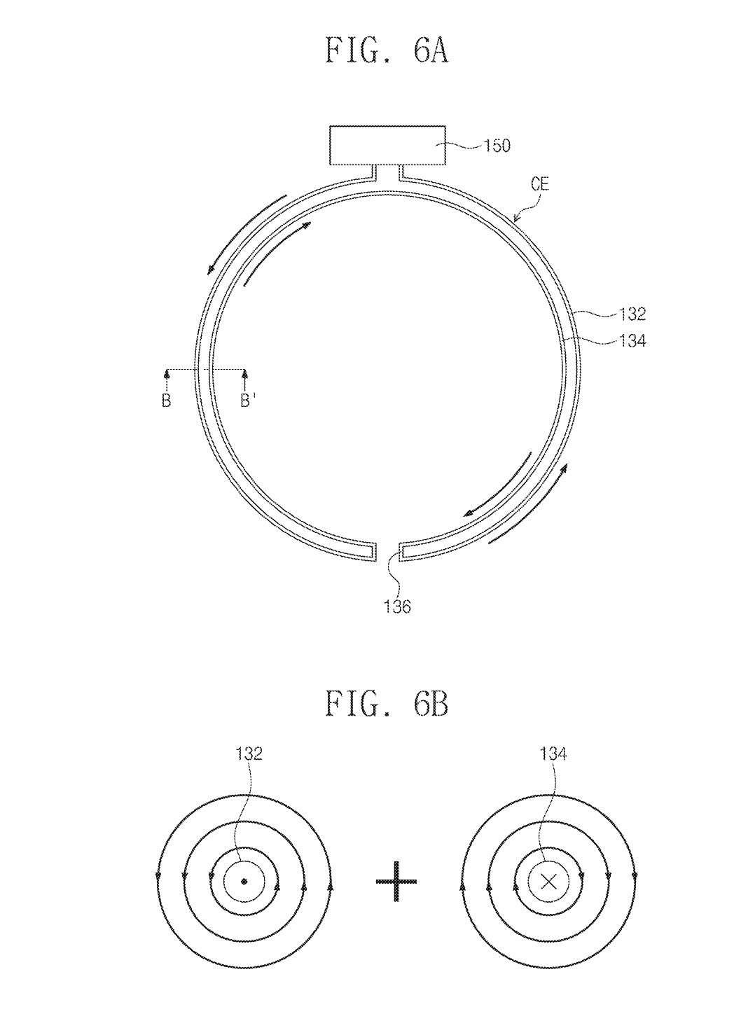

FIG. 6A is a view of a receiving-side power feeding coil CE according to a comparative example, and FIG. 6B is a cross-sectional view of magnetic fields, taken along line B-B′ of FIG. 6A. The shied unit is not provided to the receiving-side power feeding coil CE according to the comparative example. The magnetic fields having different directions may be generated in the first and second coil parts 132 and 134 through which current flows in different directions. Therefore, the cancellation of the magnetic filed in the receiving-side power feeding coil CE may increase to decrease inductance.

For example, when the inductance measured by using the receiving-side power feeding coil 130 of FIG. 5A has a value of about 1.06 uH, the inductance measured by using the receiving-side power feeding coil CE according to the comparative example may have a value of about 0.51 uH. Here, the receiving-side power feeding coils 130 and CE of FIGS. 5A and 6A may have the same process conditions, and for example, the above-described inductance values may be obtained when a diameter is about 18 cm, and a frequency is about 6.78 MHz.

According to the concept of the present disclosure, the cancellation of the magnetic field, which is generated due to characteristic of coils having open loop shapes through which the current flow in different directions, may decrease to increase the inductance. Since a shape and a function of the second shield unit 162 are also the same as or similar to those of the first shield unit 160, repeated descriptions will be omitted. Referring to FIG. 3, the first shield unit 160 is described to be provided to the receiving-side power feeding coil 130, and the second shield unit 162 is described to be provided to the receiving-side resonant coil 140 as an example, but on the other hand, the shield unit may be selectively provided to one of the receiving-side power feeding coil 130 and the receiving-side resonant coil 140.

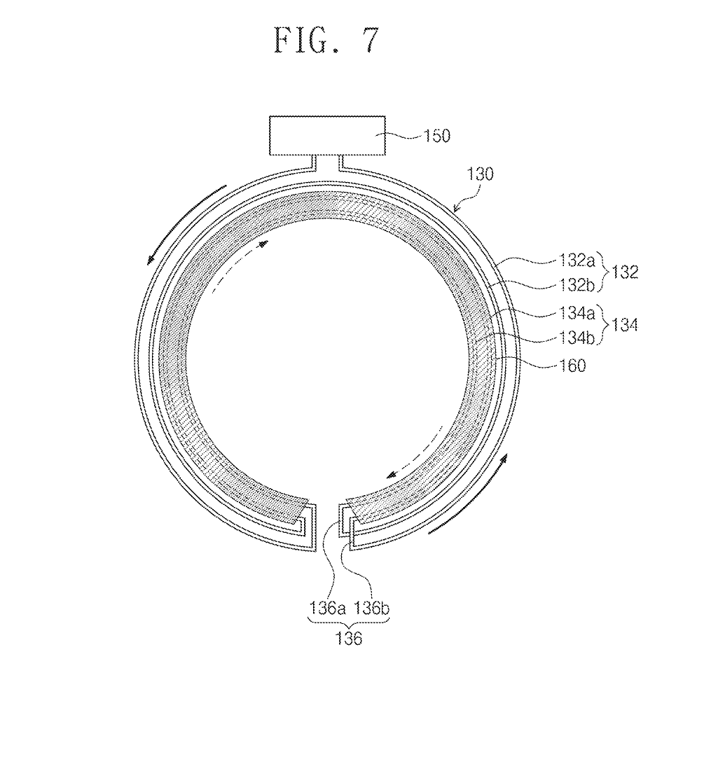

FIG. 7 is a view of a receiving-side power feeding coil 130 according to an embodiment of the inventive concept. The same reference numerals are provided to the substantially same components as the receiving-side power feeding coil described by referring FIGS. 1 to 5B, and repeated descriptions may be omitted for simplification of description. A first coil part 132, a second coil part 134, and a connection part 136 may be provided in plurality. For example, each of first coil parts 132a and 132b, second coil parts 134a and 134b, and connection parts 136a and 136b may be doubly provided. The first shield unit 160 may be provided to surround the second coil parts 134a and 134b. Therefore, due to the effect of increasing a total length of the receiving-side power feeding coil 130, the inductance may increase.

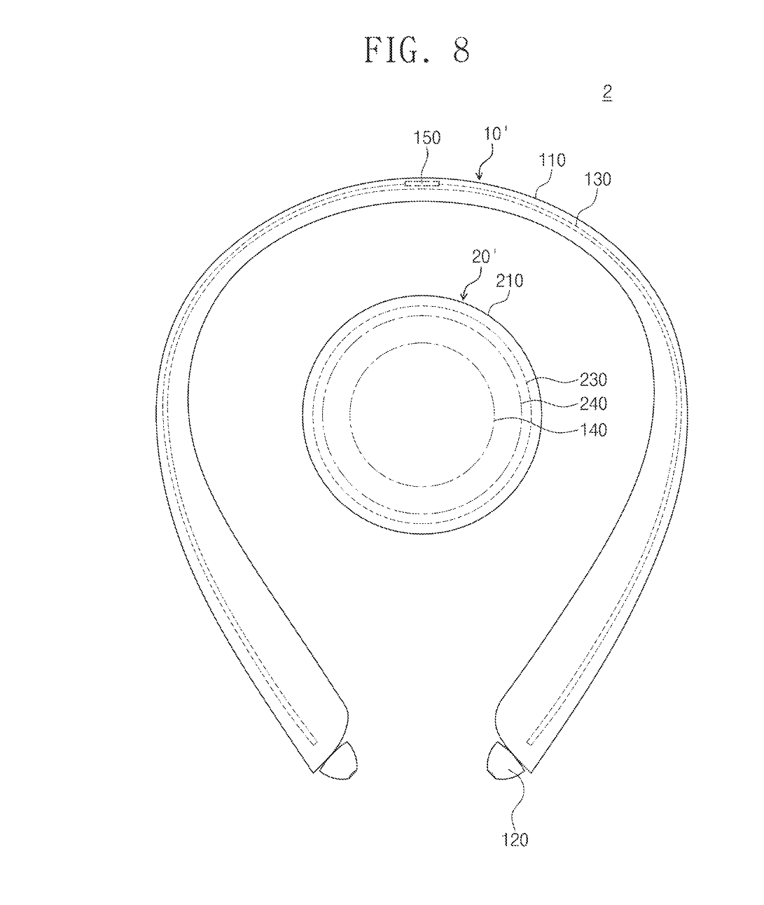

FIG. 8 is a view of an electronic device system 2 according to an embodiment of the inventive step. The same reference numerals are provided to the substantially same components as the electronic device system 1 described by referring FIGS. 1 to 4, and repeated descriptions may be omitted for simplification of description. Referring to FIG. 8, each of receiving-side and transmitting-side power feeding coils 130 and 230 is illustrated by a dotted line, and each of the receiving-side and transmitting-side resonant coils 140 and 240 is illustrated by an alternate long and short dash line.

An electronic device 10′ may include a first body 110, an earphone 120, the receiving-side power feeding coil 130, and a receiving circuit unit 150, and a wireless charger 20′ may include a second body 210, a power source 220, the transmitting-side power feeding coil 230, the transmitting-side resonant coil 240, and the receiving-side resonant coil 140. Although not shown, at least one of the receiving-side power feeding coil 130 or the receiving-side resonant coils 140 may include the above-described shield unit. For example, the receiving-side power feeding coil 130 may include the above-described first shield unit.

The electronic device 10′ may be charged from the wireless charger 20′ by disposing the electronic device 10′ to a second charge position adjacent to the wireless charger 20′. For example, a distance between the electronic device 10′ and the wireless charger 20′ may be about 10 cm or less at the second charging position.

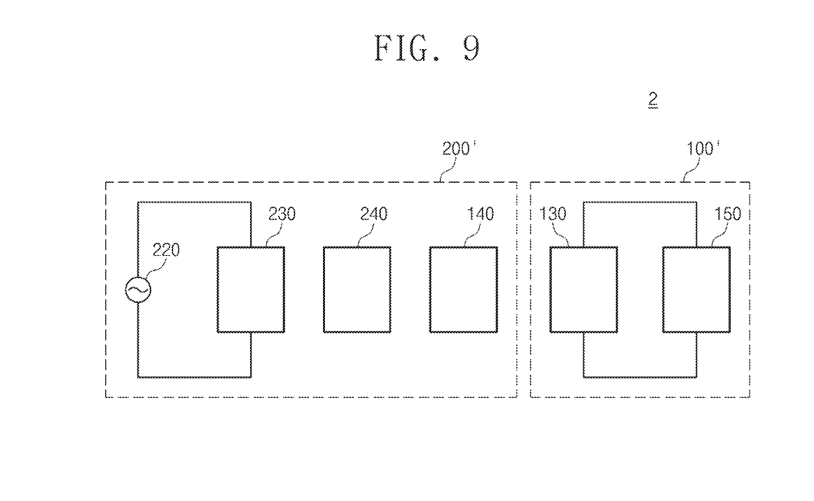

FIG. 9 illustrates a wireless power supply system of the electronic device system 2 of FIG. 8. The wireless charger 20′ may be corresponded to a wireless power transmitting device 200′, and the electronic device 10′ may be corresponded to a wireless power receiving device 100′. The wireless power transmitting device 200′ may transfer power generated in a power source 220 to the wireless power receiving device 100′. For example, the power may be transferred by magnetic resonance phenomenon.

The wireless power transmitting device 200′ may include the transmitting-side power feeding coil 230, the transmitting-side resonant coil 240, and the receiving-side resonant coil 140. On the other hand, the wireless power receiving device 100′ may include the receiving-side power feeding coil 130 and the receiving circuit unit 150. Generally, the inductance required for the receiving-side resonant coil 140 may have a value higher than that of the receiving-side power feeding coil 130. According to the embodiment of the inventive concept, the receiving-side resonant coil 140 is disposed not at the wireless power receiving device 100′ but at the wireless power transmitting device 200′ to reduce limitation of a constitution and/or a shape of the receiving-side resonant coil 140, thereby obtaining a higher value of inductance.

According to the embodiment of the inventive concept, the cancellation of the magnetic field, which is generated due to characteristic of coils having open loop shapes through which current flows in different directions, may decrease to increase the inductance. In addition, according to the embodiment of the inventive concept, the receiving-side resonant coil is disposed not at the wireless power receiving device but at the wireless power transmitting device to obtain the higher value of inductance of the receiving-side resonant coil.

Although the embodiments of the inventive concept are described with reference to the accompanying drawings, those with ordinary skill in the technical field to which the inventive concept pertains will understood that the present disclosure can be carried out in other specific forms without changing the technical idea or essential features. Therefore, the above-disclosed embodiments are to be considered in all aspects as illustrative and not restrictive.

What is claimed is:

1. An electronic device system comprising:
an electronic device having an open loop shape;
a coil within the electronic device; and
a shield unit configured to shield at least a portion of the coil,
wherein the coil comprises:
a first coil part through which current flows in a first direction; and
a second coil part through which current flows in a second direction opposite to the first direction,
wherein the shield unit is provided to at least one of the first coil part or the second coil part.

2. The electronic device system of claim 1, wherein the coil is a single coil having the open loop shape, and
the first coil part is a portion of the coil, and the second coil part is another portion of the coil.

3. The electronic device system of claim 1, wherein the coil has the open loop shape, and
the second coil is provided inside further than the first coil part, and the shield unit is provided to the second coil part.

4. The electronic device system of claim 3, wherein the shield unit is provided to surround the second coil part.

5. The electronic device system of claim 1, wherein the coil is a receiving-side resonant coil.

6. The electronic device system of claim 1, wherein the coil is a receiving-side power feeding coil.

7. The electronic device system of claim 1, wherein at least one of the first coil part or the second coil part is provided in plurality.

8. The electronic device system of claim 1, wherein the coil comprises:
a receiving-side resonant coil; and
a receiving-side power feeding coil,
wherein each of the receiving-side resonant coil and the receiving-side power feeding coil comprises the first and second coil parts,
wherein the shield unit comprises:
a first shield unit provided to the receiving-side power feeding coil; and
a second shield unit provided to the receiving-side resonant coil.

9. The electronic device system of claim 1, further comprising a wireless charger configured to charge the electronic device.

10. The electronic device system of claim 9, wherein the wireless charger comprises:
a transmitting-side power feeding coil; and
a transmitting-side resonant coil.

11. The electronic device system of claim 9, wherein the coil is a receiving-side power feeding coil,
wherein the wireless charger comprises:
a transmitting-side power feeding coil;
a transmitting-side resonant coil; and
a receiving-side resonant coil.

12. The electronic device system of claim 11, wherein the electronic device is charged when disposed at a charging position adjacent to the wireless charger, and
a distance between the electronic device and the wireless charger is about 10 cm or less at the charging position.

13. The electronic device system of claim 1, wherein the electronic device is a headset.

14. A wireless charger for charging an electronic device, the wireless charger comprising:
a transmitting-side power feeding coil;
a transmitting-side resonant coil; and
a receiving-side resonant coil.
